(19) United States
(12) Patent Application Publication
(10) Pub. No.: US 2017/0268472 A1
(43) Pub. Date: Sep. 21, 2017

(54) High-Pressure Fuel Pump Comprising a Piston

(71) Applicant: Robert Bosch GmbH, Stuttgart (DE)

(72) Inventors: Thomas KRUMBHOLZ, Stuttgart (DE); Soeren STRITZEL, Rayong (DE); Heiko JAHN, Tamm (DE)

(21) Appl. No.: 15/528,597

(22) PCT Filed: Oct. 8, 2015
(86) PCT No.: PCT/EP2015/073221

§ 371 Date: May 22, 2017

(30) Foreign Application Priority Data
Dec. 9, 2014 (DE) 10 2014 2253 19.5

(51) Int. Cl. F02M 59/44; F16J 15/3236

(52) U.S. Cl. CPC F02M 59/442; F16J 15/3236; F16J 15/3244

(57) ABSTRACT

A high-pressure fuel pump includes a piston and a sealing device. The piston includes an end portion. The sealing device is disposed on the end portion, faces a drive of the fuel pump, and is configured to radially surround the piston. The piston is displaceable along a longitudinal axis relative to the sealing device. The sealing device includes a first and a second sealing portion which extend round in a radially internal manner. The first and the second sealing portions are each located at mutually spaced-apart axial end regions of the sealing device. The first and the second sealing portions are present on an injection-molded component which is subsequently processed in a cutting manner.

### PRIOR ART

The invention relates to a high-pressure fuel pump according to the preamble of Claim 1, and two methods according to the independent patent claims.

There are commercially known fuel pumps for fuel systems for internal combustion engines in which a piston can be moved axially by means of a drive which is formed by means of a cam or an eccentric disk. A required restoring force of the piston is in this instance produced by means of a pressure spring. For example, a spring plate which is acted on by means of a pressure spring is pressed on an end portion of the piston. In this instance, a piston seal which is arranged at the radially external side on the piston can separate a first “fuel-side” portion of the piston from a second “oil-side” portion of the piston, whereby a mixing of fuel and oil is at least kept to a low level.

### STATEMENT OF INVENTION

The problem addressed by the invention is solved by a high-pressure fuel pump according to Claim 1, and by two methods according to the independent claims. Advantageous developments are set out in dependent claims. Features which are important for the invention further appear in the following description and in the drawings, wherein the features may be important for the invention both alone and in different combinations without explicit reference being made to this again.

The invention relates to a high-pressure fuel pump having a piston, on the end portion of which facing a drive there is arranged a sealing device which radially surrounds the piston, wherein the piston can be displaced along a longitudinal axis relative to the sealing device. According to the invention, the sealing device has a first and a second sealing portion which extend round in a radially internal manner, wherein the first and the second sealing portions are each arranged at mutually spaced-apart axial end regions of the sealing device, and wherein the sealing device comprises an injection-molded component which is subsequently processed in a cutting manner and on which the sealing portions are present. The sealing device according to the invention seals the high-pressure fuel pump at a radially external covering face of the piston against a fluid medium. In particular, the sealing device at an “internal” region of the high-pressure fuel pump may seal against the fuel and at an “external” region against oil. Preferably, the injection-molded component which is subsequently processed in a cutting manner is produced from a resilient material.

The invention has the advantage that—as a result of the injection-molded component which is subsequently processed in a cutting manner—the sealing device is processed in a cutting manner only to a comparatively small degree, whereby costs are saved. As a result of the total of only two sealing portions, a number of required undercuts is particularly small, whereby the machinability is therefore improved. Furthermore, a geometry of the two sealing portions can be optimized and consequently a wear of the sealing device can be reduced. Accordingly, a leakage at the piston can also be reduced.

Furthermore, a structural space required for the sealing device can be kept small. By means of the single-piece injection-molded component which is subsequently processed in a cutting manner according to the invention, production costs can be kept comparatively small, in particular with respect to a two-piece sealing device which is injection-molded in a “free-falling” manner (that is to say, without undercuts).

There may further be provision for an axial spacing between the first and the second sealing portion to correspond to at least one stroke of the piston. A particularly good sealing action is thereby achieved in the piston and the operation of the high-pressure fuel pump is consequently improved.

In an embodiment of the high-pressure fuel pump, the injection-molded component which has been subsequently processed in a cutting manner is constructed in an axially mirror-symmetrical manner. An assembly of the sealing device can thereby be carried out in a particularly simple manner.

In another embodiment of the high-pressure fuel pump, at least one axial portion of the injection-molded component which has been subsequently processed in a cutting manner is constructed in such a manner that a contact pressure changes between a contact face of the sealing portion and a covering face of the piston along the longitudinal axis. In this instance, the at least one axial portion is preferably constructed in such a manner that—in a manner brought about by the relative movement between the piston and the sealing device—a “conveying” of fluid along the covering face of the piston axially away from the sealing device is more powerful than axially in the direction toward the sealing device. The sealing action can thereby be improved and at the same time wear can be kept small.

Preferably, starting from an axial location at which the contact pressure is at a maximum, a value of a gradient of the contact pressure in a direction facing axially away from the location to the closest edge of the injection-molded component which has been subsequently processed in a cutting manner, is greater than a value of a gradient of the contact pressure in a direction facing axially away from the location to the remote edge of the injection-molded component which has been subsequently processed in a cutting manner. The sealing action of the sealing device can thereby be further improved and leakages can consequently be minimized.

In addition, there may be provision, prior to an installation of the sealing device in the high-pressure fuel pump, for a radially internal conical first wall portion at an axially external first axial portion of the injection-molded component which has been subsequently processed in a cutting manner to have with respect to a plane which is at right-angles relative to the longitudinal axis an angle a of from approximately 30 degrees to approximately 60 degrees and for a radially internal conical second wall portion to have at a second axial portion which is axially adjacent to the first axial portion with respect to the longitudinal axis an angle β which is approximately half as large as the angle α. Consequently, the above-described gradients of the contact pressure can be produced particularly well and consequently a fluid-tightness of the high-pressure fuel pump can be improved.

In another embodiment of the high-pressure fuel pump, at mutually spaced-apart axial end regions of the injection-molded component which is subsequently processed in a cutting manner a sealing bead is arranged at the radially external side in each case. As a result of the total of two sealing beads, a radially external portion of the sealing device can be sealed particularly well against a radially internal portion of a seal carrier which receives the sealing device. As a result of the two sealing beads according to the invention, axial “tilting” of the sealing device can also be prevented in an effective manner, whereby the operation can be improved and the durability can be increased. An assembly of the sealing device can also be improved.

There may further be provision for the injection-molded component which is subsequently processed in a cutting manner to comprise a perfluoroalkoxy material PFA. The perfluoroalkoxy material is particularly suitable for the comparatively high demands of a high-pressure fuel pump. As a result of the injection-molding method, production costs can be reduced. In addition, there may be provision for filler materials to be present in a state integrated in the perfluoroalkoxy material, whereby costs are reduced or the properties of the sealing device can be further improved.

Furthermore, the invention relates to a first method for producing the high-pressure fuel pump having a piston, at the end portion of which facing a drive a sealing device which radially surrounds the piston is arranged, wherein the piston can be displaced along a longitudinal axis relative to the sealing device. According to the invention, the sealing device is produced in accordance with the following steps:

(a) injection-molding an injection-molded component of the sealing device to form an initial shape, wherein the initial shape comprises an axial central hole;
(b) subsequent processing of a radially internal contour of the initial shape in a cutting manner, whereby an injection-molded component which has been subsequently processed in a cutting manner is produced with a first and a second sealing portion which extend round in a radially internal manner,
wherein the first and the second sealing portions are each arranged at mutually spaced-apart axial end regions of the injection-molded component which has been subsequently processed in a cutting manner.

The invention further relates to a second method for producing a high-pressure fuel pump having a piston, at the end portion of which facing a drive a sealing device which radially surrounds the piston is arranged, wherein the piston can be displaced along a longitudinal axis relative to the sealing device. According to the invention, the sealing device is produced in accordance with the following steps:

(a1) injection-molding an injection-molded component of the sealing device to form an initial shape;
(a2) drilling an axial central hole in the initial shape;
(b) subsequent processing of a radially internal contour of the initial shape in a cutting manner, whereby an injection-molded component which has been subsequently processed in a cutting manner and which has a first and a second sealing portion which extend round in a radially internal manner is produced, wherein the first and the second sealing portions are each arranged at mutually spaced-apart axial end regions of the injection-molded component which has been subsequently processed in a cutting manner.

The first method is therefore characterized in that the axial central hole has already also been produced by means of the injection-molding, whereby material consumption is reduced and a separate drilling operation is dispensed with. The second method is characterized in that the axial central hole is produced in a cutting manner after the injection-molding. The subsequent method step (b) is the same for both methods. The sealing device according to the invention may alternatively be produced by means of the first or the second method. In this instance, the same advantages as already described above are afforded for the completed sealing device.

Exemplary embodiments of the invention are explained below with reference to the drawings, in which:

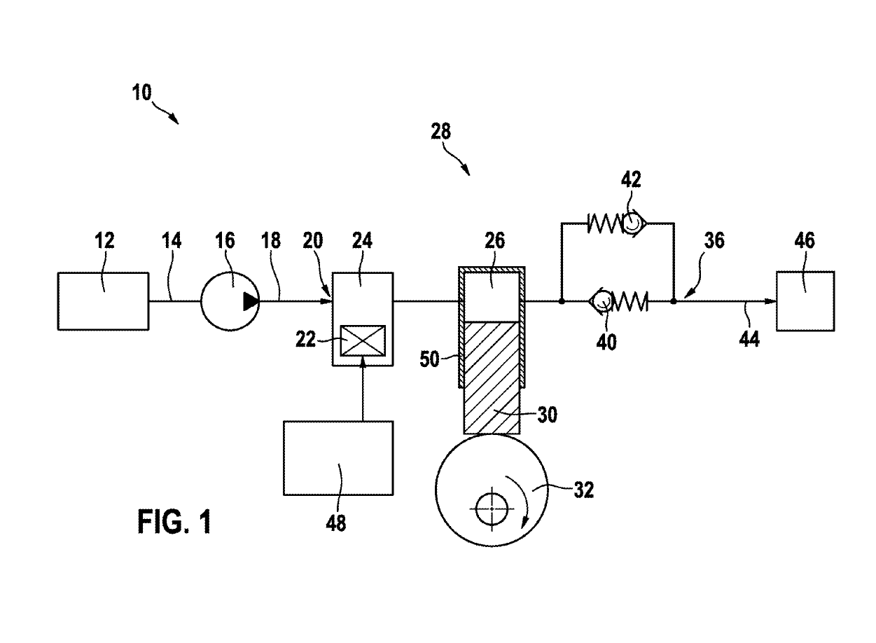

FIG. 1 is a simplified schematic illustration of a fuel system for an internal combustion engine;

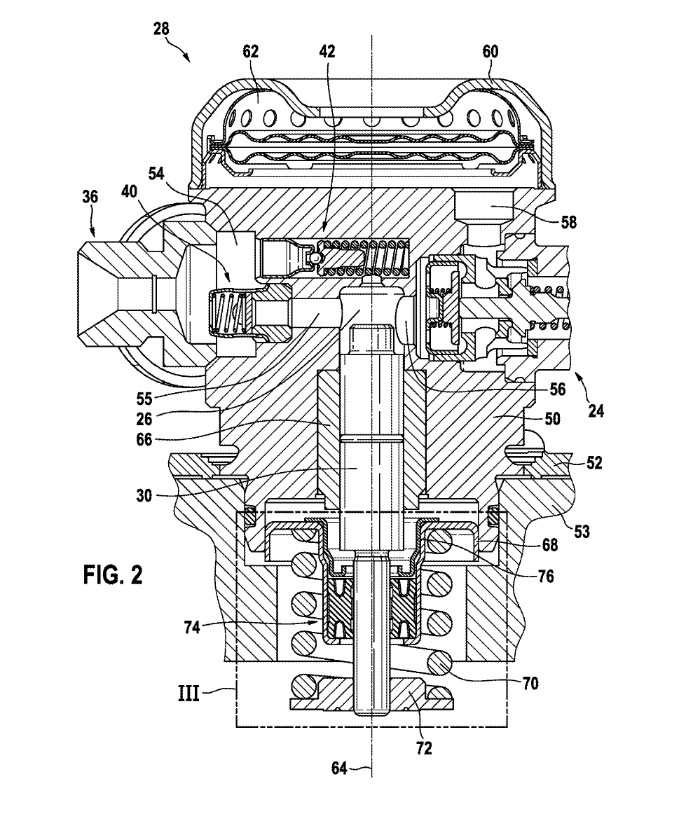

FIG. 2 is a longitudinal section through a high-pressure fuel pump of the fuel system of FIG. 1;

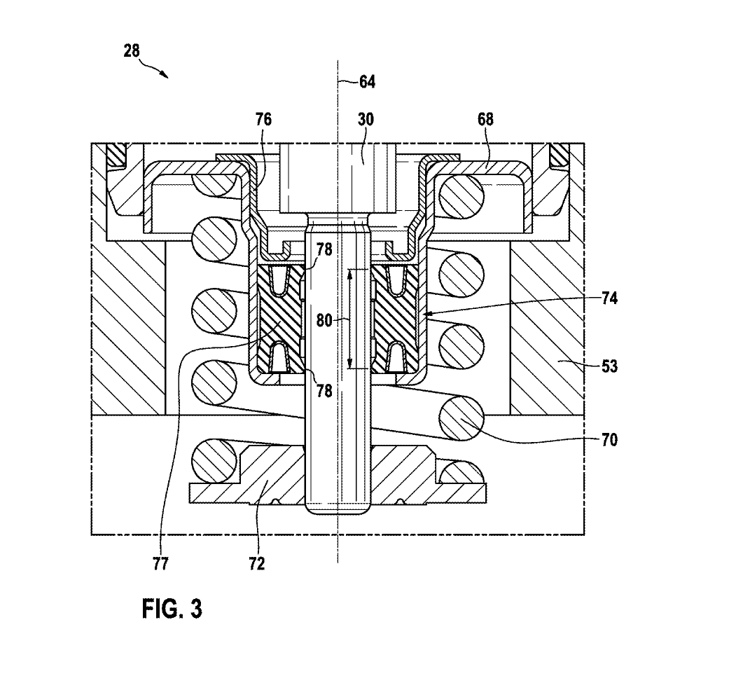

FIG. 3 is an enlarged illustration of a cut-out of FIG. 2;

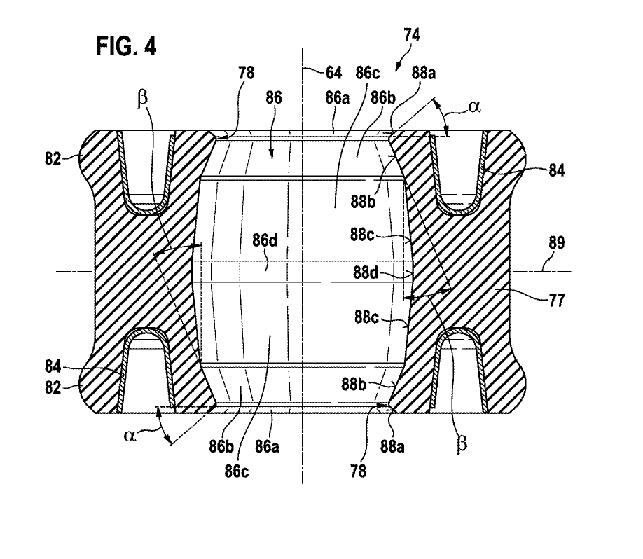

FIG. 4 is an axial sectioned view of a sealing device for a piston of the high-pressure fuel pump;

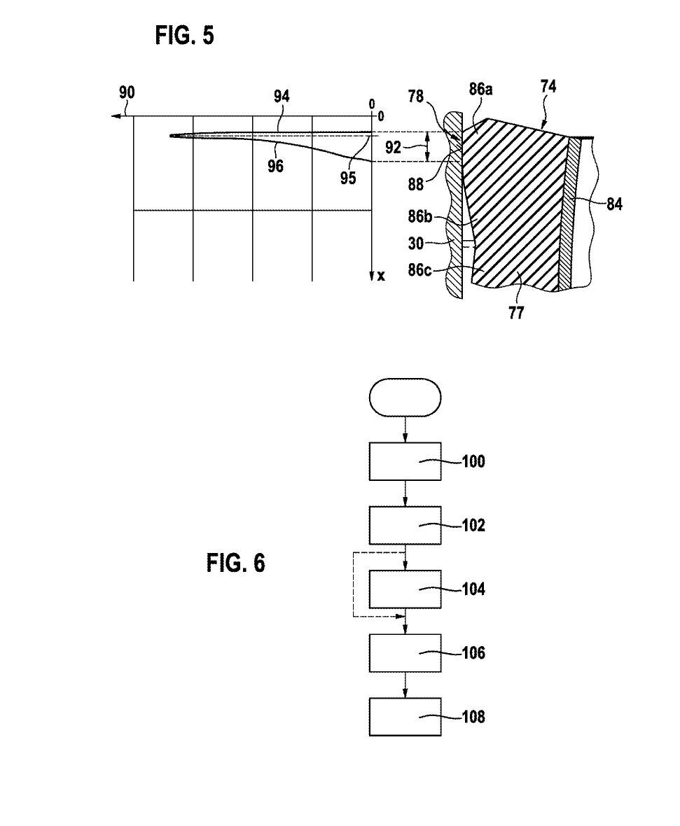

FIG. 5 is an illustration of a contact pressure on the sealing device in accordance with a longitudinal coordinate together with a sectioned view of a sealing portion of the sealing device; and

FIG. 6 is a flow chart for a method for producing the sealing device.

The same reference numerals are used for functionally equivalent elements and variables in all the Figures, even in the case of different embodiments.

FIG. 1 shows a fuel system 10 for an internal combustion engine which is not illustrated in greater detail in a simplified schematic illustration. From a fuel tank 12, fuel is supplied via a suction line 14, by means of a pre-feed pump 16, via a low-pressure line 18, via an inlet 20 of a quantity control valve 24 which can be actuated by means of an electromagnetic actuation device 22 to a conveying chamber 26 of a high-pressure fuel pump 28. For example, the quantity control valve 24 may be an inlet valve of the high-pressure fuel pump 28, which valve can be opened by means of force.

In this instance, the high-pressure fuel pump 28 is constructed as a piston pump, wherein a piston 30 can be moved vertically in the drawing by means of a cam disk 32 (“drive”). In a state hydraulically between the conveying chamber 26 and an outlet 36 of the high-pressure fuel pump 28, there is arranged an outlet valve 40 which is drawn in FIG. 1 as a resiliently loaded non-return valve which can open in the direction toward the outlet 36. The outlet 36 is connected to a high-pressure line 44 and via this to a high-pressure store 46 (“common rail”). Furthermore, there is hydraulically arranged between the outlet 36 and the conveying chamber 26 a pressure limitation valve 42 which is also drawn as a resiliently loaded non-return valve and which can open in the direction toward the conveying chamber 26.

During operation of the fuel system 10, the pre-feed pump conveys fuel from the fuel tank 12 into the low-pressure line 18. The quantity control valve 24 can be closed and opened in accordance with a respective fuel requirement. The quantity of fuel which is conveyed to the high-pressure store 46 is thereby influenced. The electromagnetic actuation device 22 is controlled by means of a control and/or regulation device 48.

FIG. 2 is an axially sectioned illustration of the high-pressure fuel pump 28 of FIG. 1. The high-pressure fuel pump 28 comprises a housing 50 which can be screwed by means of a flange 52 to an engine block 53 of the internal combustion engine. The housing 50 further has a plurality of hydraulic channels 54, 55, 56 and 58. In the upper region in FIG. 2, the high-pressure fuel pump 28 comprises a cover 60 and a pressure damper 62. The high-pressure fuel pump 28 is at least partially constructed in a rotationally symmetrical manner relative to a longitudinal axis 64.

In a left region in the drawing, the high-pressure fuel pump 28 has the outlet 36 for connecting to the high-pressure line 44. The outlet valve 40 (in a left portion in the drawing) and the pressure limitation valve 42 (in a central portion) are arranged in the housing 50 in a state hydraulically connected to the outlet 36. In a portion of the housing 50 which is at the center right in the drawing, the quantity control valve 24 is arranged.

The high-pressure fuel pump 28 further comprises: the conveying chamber 26, the piston 30 and a bushing 66. The piston 30 which can be displaced along the longitudinal axis 64 is constructed as a so-called “stepped piston” and substantially has two portions, a first portion (at the top in the drawing) having a comparatively large diameter, by means of which it is guided in the bushing 66, and a second portion (at the bottom in the drawing) having a comparatively small diameter.

A lower region of FIG. 2 is indicated by a frame III and illustrated in an enlarged state in FIG. 3. In particular, FIG. 3 shows a seal carrier 68 which is constructed substantially in a pot-like manner and a piston spring 70 which is arranged at the radially external side around a portion of the seal carrier 68 and which is constructed as a helical spring and which is supported with an end portion on the seal carrier 68, for which reason it is also referred to as a “spring receiving member”. At an end portion of the piston 30, which portion is at the bottom in the drawing and faces the drive, there is pressed a spring plate 72 on which an end portion of the piston spring 70 is received.

Radially inside the seal carrier 68, there is arranged a piston seal which is referred to as a sealing device 74 (also referred to as “low-pressure seal”) and which radially surrounds the lower second portion (facing the drive) of the piston 30 and seals a fluid chamber (“stepped chamber”) which is provided between the housing 50 and the seal carrier 68 in an outward direction toward the engine block 53. The piston 30 can be displaced along the longitudinal axis 64 relative to the sealing device 74. As a rough approximation, the sealing device 74 has a generally annular structure.

In this instance, the sealing device 74 in FIG. 2 is axially supported in an upward direction by a retention portion 76 which is arranged inside the seal carrier 68 and which is also constructed in a substantially hat-like manner. In the drawing, a spatial region above the sealing device 74 characterizes a “fuel side” and a spatial region below the sealing device 74 characterizes an “oil side”.

Furthermore, the sealing device 74 in FIG. 2 is axially supported in a downward direction by means of a radially inwardly bent peripheral edge portion of the seal carrier 68. Of course, the sealing device 74 may optionally have a small axial play within a region determined by the retention portion 76 and the edge portion mentioned.

The sealing device 74 is arranged radially externally on the piston 30 along the longitudinal axis 64. In this instance, the sealing device 74 is constructed in a substantially rotationally symmetrical manner, wherein in the drawing upper and lower portions of the sealing device 74 are constructed in an axially mirror-symmetrical manner with respect to each other. According to the invention, the sealing device 74 comprises an injection-molded component 77 which has been subsequently processed in a cutting manner. It preferably comprises a resilient material, preferably a perfluoroalkoxy material (“PFA”) or is produced therefrom, and it is produced using an injection-molding method. Furthermore, it can be seen that the injection-molded component 77 of the sealing device 74, which component has been subsequently processed in a cutting manner, has at mutually spaced-apart axial end regions at the radially internal side only one peripheral sealing portion 78. By means of the sealing portions 78, a “dynamic” sealing is carried out with respect to the piston 30 which can be axially moved relative to the sealing device 74.

Preferably, an axial spacing 80 of the sealing portions 78 corresponds to at least one stroke of the piston 30. The sealing portions 78 can thereby “scrape off” the fuel (in the drawing above the sealing device 74) or the oil (in the drawing below the sealing device 74) particularly well and consequently prevent or at least minimize mixing of the fuel with the oil.

FIG. 4 shows the sealing device 74 in a sectioned view which is enlarged again. In this instance, however, the sealing device 74 is present as an individual component which is not impaired, that is to say, it is in this instance not deformed by the piston 30 or the seal carrier 68. The sealing device 74 is constructed at least substantially in a rotationally symmetrical manner with respect to the longitudinal axis 64. Furthermore, the sealing device 74 is constructed in a mirror-symmetrical manner with respect to a transverse plane 89 (which is horizontal in the drawing and at right-angles with respect to the longitudinal axis 64).

Furthermore, the injection-molded component 77 of the sealing device 74, which component has been subsequently processed in a cutting manner, comprises at mutually spaced-apart axial end regions at the radially external side a peripheral sealing bead 82. Using the sealing beads 82, the sealing device 74 can be sealed “statically” against a radially internal portion of the seal carrier 68. To this end, the sealing device 74 is arranged in a non-positive-locking manner in the seal carrier 68. In a radially central portion of the injection-molded component 77 of the sealing device 74, which component has been subsequently processed in a cutting manner, there are received at mutually spaced-apart axial end regions of the sealing device 74 radially peripheral and to this extent annular springs 84 which are each produced from a resilient metal sheet and which are constructed in the plane of section of FIG. 4 in a substantially U-shaped manner. The springs 84 are open in an upward direction or in a downward direction in FIG. 4, respectively. As a result of the springs 84, on the one hand, the two sealing portions 78 are urged against the piston 30 and, on the other hand, the sealing beads 82 are urged against the seal carrier 68.

At the radially internal side around the longitudinal axis 64, the sealing device 74 has a rotationally symmetrical central recess 86 in the manner of a through-hole. The recess 86 comprises two (in each case external) first axial portions 86a, adjacent thereto two (in each case “central”) second axial portions 86b and adjacent thereto two (in each case internal) third axial portions 86c. Axially centrally between the third axial portions 86c, a single fourth axial portion 86d is arranged. The first, second and third axial portions 86a, 86b and 86c and the fourth axial portion 86d each have associated radially internal first, second, third and fourth wall portions 88a, 88b, 88c and 88d.

A radially internal contour of the recess 86, which contour is formed by the first, second and third wall portions 88a, 88b and 88c, is conical in each case. In this instance, the first axial portions 86a each open axially outward. The second and third axial portions 86b and 86c open in each case axially inward, that is to say, in the direction toward the transverse plane 89. However, the axially internal fourth wall portion 88d is constructed parallel with the longitudinal axis 64, that is to say, in a cylindrical manner.

The conical first wall portions 88a have in each case with respect to a plane which is at right-angles with respect to the longitudinal axis 64 an angle a of from approximately 30 degrees to approximately 60 degrees. The conical second wall portions 88b have with respect to the longitudinal axis 64 in each case an angle β. In this instance, the angle β is preferably (but not necessarily) constructed to be approximately half as large as the angle α. The conical third wall portions 88c have with respect to the longitudinal axis 64 in each case an angle γ (not illustrated in the drawing), wherein the angle γ is preferably smaller than the angle β.

Within the regions set out, the angles α and β may have different dimensions in accordance with an embodiment of the sealing device 74. In this instance (in the installed state of the sealing device 74, that is to say, when the sealing device 74 is arranged at the radially external side on the piston 30), the angles α and β have a comparatively large influence on the shape and size of a contact face 88 and in particular on the forces which are produced at the contact face 88, cf. FIG. 5 below.

FIG. 5 shows in a region on the left in the drawing a graph in which a contact pressure 90 of the sealing device 74 is indicated in accordance with a longitudinal coordinate x (parallel with the longitudinal axis 64). On the abscissa of the coordinate system illustrated, which abscissa is designated “x” and is directed perpendicularly downward in FIG. 5, the contact pressure 90 is zero. At the right in the drawing, an associated sectioned view is shown in a region of the sealing portion 78 of the sealing device 74 and a region of the piston 30. A vertical line which adjoins the sealing portion 78 corresponds to a covering face of the piston 30 which the sealing portion 78 therefore abuts. An axial length 92 of the sealing portion 78 characterizes an overall pressing force of the sealing device 74 on the piston 30. In this instance, the sealing device 74 is thus deformed.

The first, second, third and fourth axial portions 86a, 86b, 86c and 86d of the sealing device 74 and the associated first, second, third and fourth wall portions 88a, 88b, 88c and 88d are constructed in such a manner that the contact pressure 90 on the contact face 88 changes between the sealing portion 78 and the covering face of the piston 30 along the longitudinal axis 64 or along the longitudinal coordinate x. In FIG. 5, the contact pressure 90 increases steeply from a value “0/0” along the longitudinal coordinate x in a first curve portion 94 and reaches a sharp maximum at a location of the longitudinal coordinate x designated 95. Further along the longitudinal coordinate x, the contact pressure 90 decreases steeply in a second curve portion 96.

Starting from the axial location 95, at which the contact pressure 90 is at a maximum, a value of a gradient (pitch) of the contact pressure 90 in a direction which faces axially from the location 95 to the closest edge of the sealing device 74 is greater than a value of a gradient of the contact pressure 90 in a direction facing axially from the location 95 to the remote edge of the sealing device 74. The closest edge faces the first axial portion 86a of the sealing device 74, and the remote edge faces the second axial portion 86b of the sealing device 74.

In particular with the sizing of the sealing device 74 according to FIG. 4, the line path of the contact pressure 90 shown in FIG. 5 can be achieved. This advantageously enables a “transport” of fluid in an axial direction along the sealing portion 78 in an axially inward direction in respect of the sealing device 74 to be less than in an axially outward direction. The sealing action can thereby generally be significantly improved. Since the sealing device 74 in each case has only a single axially external sealing portion 78, therefore, there are in this instance no axially “internal” sealing portions which would be poorly lubricated owing to lack of fluid where applicable and consequently could be subjected to premature wear.

The geometry of the sealing device 74 may in particular be optimized according to the invention by means of numerical methods (FEM, Finite Element Method). In this instance, a plurality of parameters which characterize the sealing device 74 can be adapted. For example, it may be an objective to establish an optimum “sealing angle” in accordance with the desired contact pressure 90 or also an optimum contour of the sealing beads 82. The latter can be optimized with respect to a static sealing and a radial pressing action, whereby inter alia any translational movement of the sealing device 74 along the longitudinal axis 64 can also be minimized or even prevented.

The sealing beads 82 are as already described above arranged at axially remote portions of the sealing device and can consequently in particular prevent “tilting” of the sealing device 74 with respect to the longitudinal axis 64. The geometry of the first, second, third and fourth axial portions 86a, 86b, 86c and 86d (described in FIG. 4) of the sealing device 74 may, for example, also be optimized with respect to improved pressing on the piston 30 and on any desired operating properties.

FIG. 6 shows a flow chart for a method for producing the sealing device 74 of the high-pressure fuel pump 28 according to FIGS. 2 to 5. The procedure illustrated in FIG. 6 begins in a starting block 100.

In a following block 102, an injection-molding of the sealing device 74 is carried out to form an initial shape. In a following block 104, an axially central hole is drilled in the initial shape. In a following block 106, a subsequent processing operation of a radially internal contour of the injection-molded or drilled initial shape is carried out in a cutting manner, whereby a first and a second radially internal peripheral sealing portion 78 are produced, wherein the first and the second sealing portions 78 are each arranged at mutually spaced-apart axial end regions of the sealing device 74. In a subsequent end block 108, the procedure illustrated in FIG. 6 ends.

In a preferred alternative embodiment of the method for producing the sealing device 74, the initial shape which is produced in the block 102 already comprises the axially central hole which in this instance is not produced by means of a separate drilling operation. Therefore, the drilling operation in the block 104 can be dispensed with which is indicated in FIG. 6 by a broken line (externally around the block 104).

1. A high-pressure fuel pump comprising:
a piston including an end portion; and
a sealing device disposed on the end portion and facing a drive of the fuel pump, the sealing device configured to radially surround the piston,
wherein the piston is displaceable along a longitudinal axis relative to the sealing device,
wherein the sealing device includes a first and a second sealing portion which extend round in a radially internal manner,
wherein the first and the second sealing portions are each located mutually spaced-apart axial end regions of the sealing device, and
wherein the first and the second sealing portions are present on an injection-molded component which is subsequently processed in a cutting manner.

2. The high-pressure fuel pump as claimed in claim 1, wherein an axial spacing between the first and the second sealing portions corresponds to at least one stroke of the piston.

3. The high-pressure fuel pump as claimed in claim 1, wherein the injection-molded component axially mirror-symmetrical.

4. The high-pressure fuel pump as claimed in claim 1, wherein at least one axial portion of the injection-molded component is configured to cause a change in a contact pressure between a contact face of the sealing portion and a covering face of the piston along the longitudinal axis.

5. The high-pressure fuel pump as claimed in claim 4, wherein:
the contact pressure is at a maximum at an axial location;
a value a first gradient of the contact pressure in a direction facing axially away from the axial location to a closest edge of the injection-molded component is greater than a value a second gradient of the contact pressure in a direction facing axially away from the axial location to a remote edge of the injection-molded component.

6. The high-pressure fuel pump as claimed in claim 4, wherein prior to an installation of the sealing device in the high-pressure fuel pump (i) a radially internal conical first wall portion at an axially external first axial portion of the injection-molded component which has been subsequently processed in a cutting manner has with respect to a plane which is at right-angles relative to the longitudinal axis a first angle of from 30 degrees to 60 degrees, and (ii) a radially internal conical second wall portion has at a second axial portion which is axially adjacent to the first axial portion with respect to the longitudinal axis a second angle which is approximately half the first angle.

7. The high-pressure fuel pump as claimed in claim 1, further comprising:
a sealing bead located at a radially external side of each of the mutually spaced-apart axial end regions of the injection-molded component.

8. The high-pressure fuel pump as claimed in claim 1, wherein the injection-molded component includes a perfluoroalkoxy material.

9. A method for producing a sealing device for a high-pressure fuel pump having a piston, the sealing device radially surrounding the piston, the method comprising:
injection-molding an injection-molded component of the sealing device to form an initial shape defining an axial central hole; and
processing a radially internal contour of the initial shape in a cutting manner, such that the injection-molded component is produced with a first and a second sealing portion which extend round in a radially internal manner,
wherein the first and the second sealing portions are each arranged at mutually spaced-apart axial end regions of the injection-molded component.

10. A method for producing a sealing device for a high-pressure fuel pump having a piston, the sealing device radially surrounding the piston the method comprising:
injection-molding an injection-molded component of the sealing device to form an initial shape;
drilling an axial central hole in the initial shape; and
subsequent processing of a radially internal contour of the initial shape in a cutting manner, to form a first and a second sealing portion which extend round in a radially internal manner,
wherein the first and the second sealing portions are each arranged at mutually spaced-apart axial end regions of the injection-molded.
